(19) United States
(12) Patent Application Publication
(10) Pub. No.: US 2020/0240393 A1
(43) Pub. Date: Jul. 30, 2020

(54) WIND TURBINE PROPELLER REGULATOR TO PRODUCE UNINTERRUPTED ELECTRICITY AND LONGER BEARING LIFE

(71) Applicant: Samuel Messinger, Ramot Bet Shemish (IL)

(72) Inventor: Samuel Messinger, Ramot Bet Shemish (IL)

(21) Appl. No.: 16/548,848

(22) Filed: Aug. 23, 2019

Related U.S. Application Data
(60) Provisional application No. 62/722,899, filed on Aug. 25, 2018.

(51) Int. Cl. F03D 7/02; H02P 9/04; F03D 1/06; F03D 80/60

(52) U.S. Cl. CPC F03D 7/0276; H02P 9/04; H02P 2101/15; F03D 80/60; F03D 7/0244; F03D 1/0675

(57) ABSTRACT

An improved wind turbine device of present invention provides continues rotation of propeller and prevents stopping or critical slowing of the propeller of the turbine that causes damage to the bearing and gear assembly and shortens the life of the turbine. The wind turbine device or system of present invention is comprising of a novel hollow propeller blades having a pair of reservoirs at the top and bottom of the propeller blades and a hydraulic pump configured between the reservoirs within the hollow propeller blades along with the wireless control unit that commands the pump to manipulate the fluid present within the reservoirs to create an imbalance within the hollow propeller causing the hollow propeller to keep from stopping. Also, the wireless control unit commands the pump to manipulate the fluid of the reservoirs in reverse direction in high wind condition to prevent the propeller from rotating excessively that may cause damage and loss of electricity.

### CROSS REFERENCE TO RELATED APPLICATION

This application claims priority from U.S. Patent Application No. 62/722,899 filed on Aug. 25, 2018, which is incorporated by reference herein in its entirety.

### FIELD OF THE INVENTION

The present invention relates to the wind turbine system. More particularly, the present invention relates to a wind turbine with at least one novel hollow propeller blade with one or more reservoir of fluids at both the tip of the hollow propeller blade and at the stem near the hub of the turbine to allow manipulation of fluid within the reservoirs back and forth to keep the propeller moving when wind speeds are slow or the propeller is stationary due to no wind or there is a resolution of wind forces to stop the propeller. This control of propeller rotation will generate a more uniform predicable manufacture of electrical current and result in longer life of the system.

### BACKGROUND OF THE INVENTION

As we know, the wind turbine is a device that converts the kinetic energy of wind into the electrical energy using a simple principle that the energy in the wind rotates the propeller like blades of the rotor of the turbine which is normally connected to the rotor shaft of the generator using the main shaft and which spins the rotor shaft of generator creating electricity from the kinetic energy of the wind. Based on the design of the rotor, wind turbines are conventionally classified as Horizontal axis wind turbine and Vertical axis wind turbine. The rotation of the propellers is often 15 rpm which is converted thru mechanical gears and bearings to 1800 rpm to produce electricity. To date the propellers have been designed exclusively for their aerodynamic properties such as for aircraft application.

Most of the large wind turbines use a wind sensor coupled with the servo motor on the top of the nacelle to turn the turbine into the wind so that rotor can rotate. But, due to large size and heavy weight of the propeller (often weighing 36,000 lbs. each) the wind turbine which requires heavy wind force to rotate, and as the wind currents are fickle and unpredictable sometimes stopping the propeller rotation altogether either by lack of wind or resolution of conflicting winds resulting in a zero-sum net effect on the rotor. This creates metal to metal contact between the rolling elements of the bearing from lack of lubrication. This low rpm rotation or stoppage results in the more repairs and maintenance and loss of electricity production and shorter life of the system.

Wind turbines are designed to have a service life of 20 years, but bearings and other parts fail from the erratic nature of the wind causing the rotor to stop and start and accelerate wildly. Propellers are huge often 250 feet in length and weigh 20 tons or more and they are getting larger and heavier. The propellers usually rotate froth 5-20 rpm and 15 rpm is often said to be the ideal speed. However, the wind is erratic and not always predictable. Often the wind is such that the propeller stops completely. This causes metal to metal contact with bearings and other parts and causes damage to the integrity of the metal parts in the bearings. Fretting occurs and scuffing as well as lubricant starvation. The bearing life is severely compromised as continuous uninterrupted electrohydrodynamic (EHL) lubrication is essential for normal L10 bearing predicted life.

Further, as mentioned above, the upper limit of safe electricity generation is 25 rpm, mostly exceeded during typhoons, hurricanes and in climate weather. Places like some parts of UK, where they are claimed to be too windy, there is more probability of or chances of accident which may cause damage to life and properties as well. In UK alone, there have been 1500 accidents recorded by the RenewableUK the industry body due to heavy wind resulting 4 deaths and 300 injured in last five years.

Therefore, there exists a need of a wind turbine device and system that can control and keep speed of rotation at a desired safe speed eliminating chances of accidents due to high wind or stoppage of turbine due to low or no wind. Further, there exists a need of a wind turbine device or system that does not allow rotation of propeller beyond the maximum and minimum rotation speed limit of the turbine. Also, there is a need of wind turbine to produce a constant flow of electricity to maximize electrical production.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The subject matter of present invention discloses a wind turbine system with novel hollow propeller and propeller blades that are capable of rotating even when the speed of wind is low or when the propeller is stationary due to no wind or a resolution of forces to stop the propeller. The wind turbine of present invention is comprising of a novel propeller assembly made of plurality of rotor blades and a hub. Where each of the plurality of rotor blades of the hollow propeller are further comprising of a pair of fluid reservoir at the tip of the blade and at the stem near the hub of the blade, configured within the hollow space within the blades and connected through the hydraulic pump. Each of plurality of hollow blades of the propeller is further comprising of wireless control module communicatively coupled to the hydraulic pump.

According to an embodiment, the wind turbine device is further comprising of a wireless shaft rotation monitor sensor attached to the main shaft of the propeller and an anemometer configured over the nacelle that respectively monitors angle and position of the shaft and hence angle and position of blades of propeller and speed of wind and sends that data to the wireless control module within the propeller which in turn transfers fluids back and forth within the reservoirs of the blades creating an un-balance within the blades making the propeller to keep rotating at desired speed in any kind of wind condition. During rotation each propeller so configured will have fluids in each propeller manipulated to different locations in the rotation cycle to facilitate the movement of the entire assembly.

According to one embodiment, the wind turbine system is capable of reverse action in conditions of heavy wind when the speed of rotation reaches a maximum limit. The wind turbine system manipulates fluid in the reservoirs within the blades of the propeller in a manner that decreases speed of rotation of the propeller in the high wind conditions and keeps the rotation of the turbine at desired average speed to decrease chances of accident and to keep electricity generation at maximum.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 illustrates a left-hand side perspective view of the wind turbine with a unique hollow propeller disclosed herein in accordance with the one embodiment of the present invention.

FIG. 2 illustrates a front perspective view of the wind turbine with unique hollow propeller of FIG. 1.

FIG. 3 illustrates a perspective view along with C-C line of one unique hollow propeller disclosed herein.

FIG. 4 illustrates a longitudinal cross-sectional view of FIG. 3 of the unique hollow propeller.

FIG. 5A and FIG. 5B illustrates front views of the clockwise and anti-clockwise rotations respectively of the unique hollow propeller disclosed herein accordance with the one embodiment of the present invention.

FIG. 6 illustrates an exploded view of the nacelle assembly of the wind turbine system comprising the wireless shaft rotation monitor sensor and the anemometer.

FIG. 7 illustrates another exemplary embodiment of a propeller with a pair of symmetrical blades of present invention in between two shorter hollow blades to manipulate the rotation.

FIGS. 8A, 8B and 8C discloses a retrofitting of fluid reservoirs and enclosing it over traditional existing wind turbine propeller blades.

### DETAILED DESCRIPTION OF INVENTION

The present invention overcomes the aforesaid drawbacks of the above, and other objects, features and advantages of the present invention will now be described in greater detail. Also, the following description includes various specific details and are to be regarded as merely exemplary. Accordingly, those of ordinary skill in the art will recognize that: without departing from the scope and spirit of the present disclosure and its various embodiments there may be any number of changes and modifications described herein.

“Propeller” as described in the present invention may be defined as essentially a hub and blades. The blade shape is defined by profiles, chosen for their aerodynamic performance.

According to an embodiment, the present invention provides a wind turbine system that is capable of creating imbalance within the propeller to rotate it even when the speed of wind is low or the propeller is stationary due to no wind or a resolution of forces to stop the propeller. Further, the present invention provides a wind turbine system that prevents stopping or critical slowing of the propeller that causes damage to the bearing and gear assembly and shortens the life of the wind turbine system. According to an embodiment, the system of present invention also works in reverse condition to slow down the motion of the propeller when speed increases maximum speed limit of 25 rpm, which is considered dangerous in most wind turbine applications. According to one embodiment, the system of present invention is for combining aerodynamic and non-aerodynamic of the hollow propeller to generate electricity through rotation

According to an embodiment, the system of present invention is a wind turbine system having novel hollow propeller comprising of plurality of blades having plurality of reservoirs for fluids at the end and at the stem near the hub of the propeller within the hollow space of the propeller blades to manipulate fluids back and forth within the blade of the propeller to create imbalance and to keep the propeller in rotation at the desired speed even in less or no air situation or in high air situations. According to an embodiment, the wind turbine system of the present invention is further comprising of an hydraulic pump communicatively coupled with wireless control, where the hydraulic pump connects the plurality of reservoirs within each of the blades of the propeller to direct the flow of the fluid within the reservoir of blades to control and keep the motion of the propeller at desired speed in low, high or no wind conditions. The wind turbine system of the present invention includes a reserve tank within the nacelle of the turbine that collects fluid from all the reservoirs of the blades when the wind speed and speed of rotation of propeller is normal and does not require external efforts for its motion.

According to one embodiment, the wind turbine system of the present invention further comprises a wireless shaft location monitor sensor connected to the shaft of the wind turbine and an anemometer that are configured to monitor speed of wind and rotation of shaft, and which send activation signal to the wireless control of the hydraulic pump to transfer the fluid from the bottom reservoir to the top reservoir and fill the top reservoir of the blade at the top of the rotation cycle. According to one more embodiment of the invention, the wind turbine system of present invention may further comprise an electromechanical heating unit to heat the fluid to a temperature able to prevent freezing of the wind turbine and maintain continues rotation of propeller in cold weather.

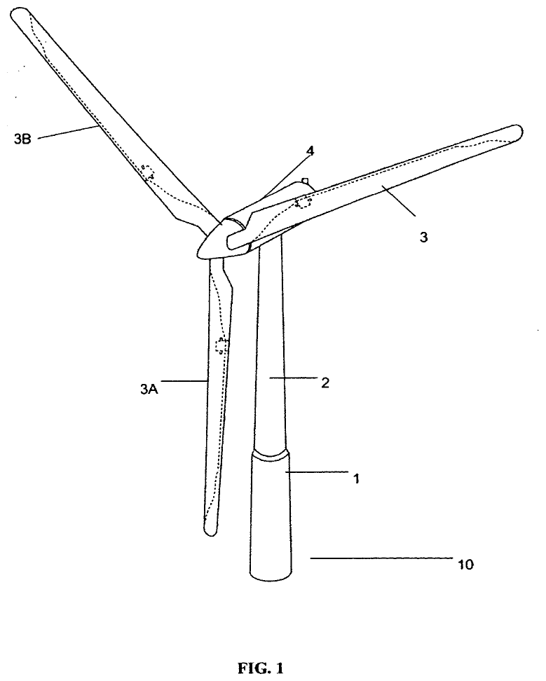

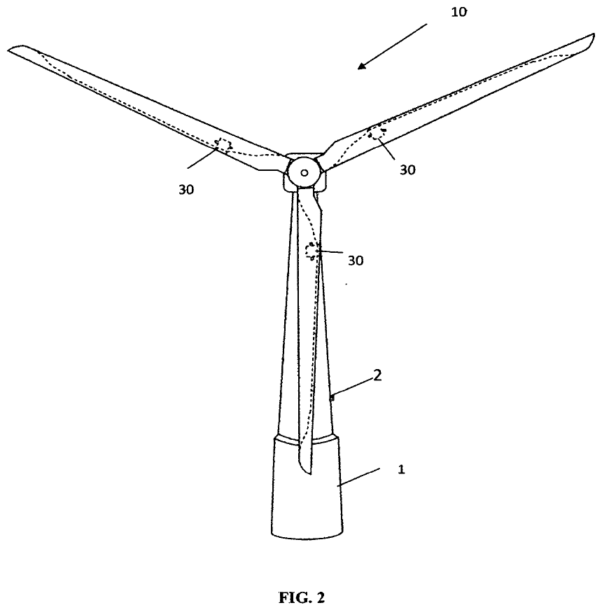

Now, referring to FIG. 1 and FIG. 2 which exemplarily illustrates a left-hand side perspective view and a front perspective view respectively of the wind turbine system 10 with a unique hollow propeller with propeller blades (3, 3A & 3B) in accordance of the present invention. According to present embodiment, the wind turbine system 10 is fixed on the ground using primary or base support 1 that supports and holds the wind turbine steady and in fixed position; a secondary support member 2 that connects and supports the novel hollow propeller (3, 3A, 3B), nacelle 4 and other top units of the system 10 with the primary support 1. The aforesaid figure further discloses a hydraulic pump 30 configured within the hollow propellers (3, 3A 3B) to back and forth transfer of fluid within the reservoirs (not shown) of the blades of propeller (3, 3A 38).

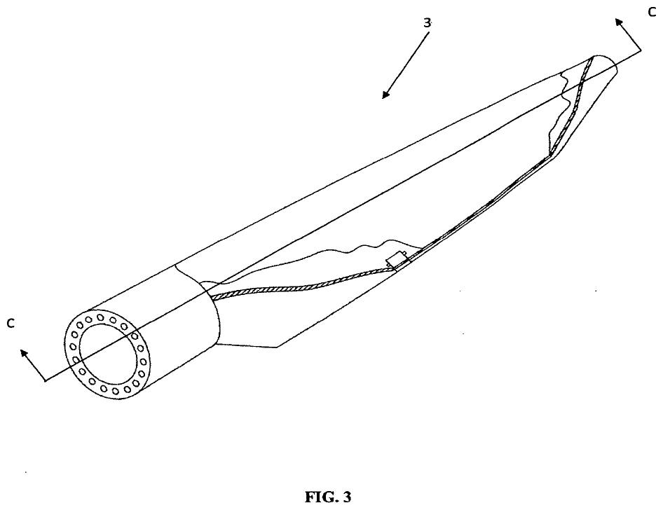

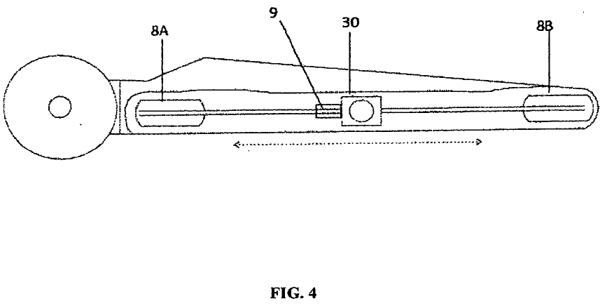

FIG. 3 and FIG. 4 illustrates perspective view with C-C line and longitudinal cross-sectional view of one unique hollow propeller 3 of the wind turbine system of present invention respectively. The hollow propeller 3 of according to present embodiment is comprising of hollow body of propeller 3 having a pair of fluid reservoir (8B & 8A) within the hollow section of the propeller 3 at the top end and bottom end of the propeller 3 and a hydraulic pump 30 configured between both the reservoirs (8B & 8A) along with the wireless control unit 9 that receives wind speed and propeller shaft position data from anemometer and sensor and controls the operation of pump according to that received data.

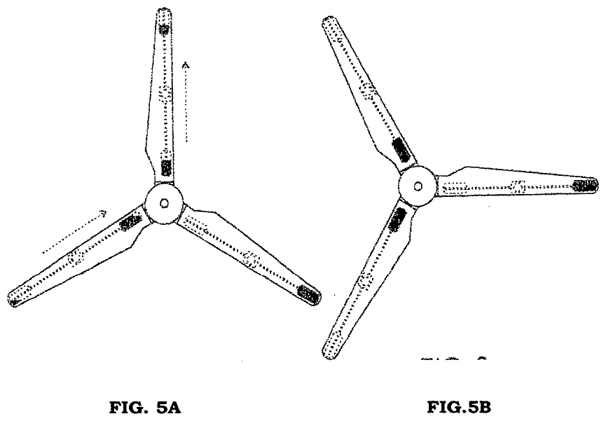

Now referring to FIG. 5A and Figure SB that illustrates front views of the clockwise and anti-clockwise rotations respectively of the unique hollow propeller and the direction of flow of fluid within the hollow propeller in in both the rotation is shown. According to one embodiment, the mode of working of the internal hydraulic of the propeller is described as: when the propeller slows to a critical speed i.e. less than 15 km/h due to low wind, the wireless control unit 9 of the propeller commands the pump 30 to pump the fluid into the reservoir at the top of the propeller cycle as a counterweight to increase the weight of that propeller and to accelerate the down speed. At a lower point in the revolution cycle, the wireless control unit 9 commands the pump 30 to pump out the fluid of the top reservoir into the bottom reservoir and into the reserve tank within the nacelle (not shown). The process is repeated as needed to keep the rpm of the propeller at a desired count. Moreover, according to an embodiment, the wind turbine system is also capable to manipulate the fluid in the reservoirs of hollow propeller to slow down the propeller when speed of wind is more than a 90 km/h or the speed of rotation of propeller is more than maximum limit of 25 rpm.

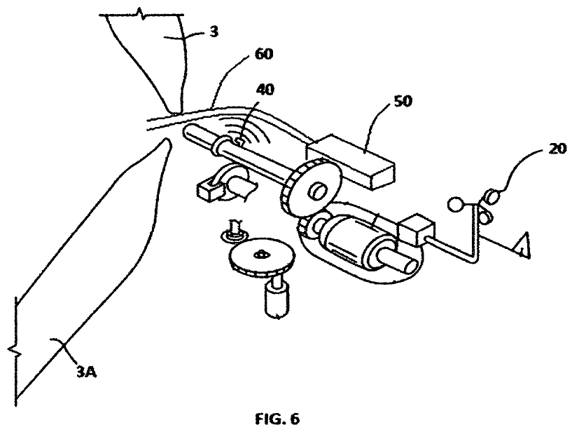

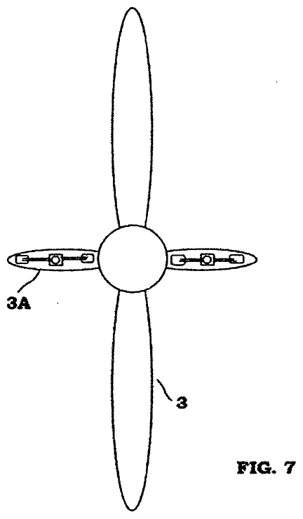

FIG. 6 illustrates an exploded view of the nacelle of the wind turbine system comprising the wireless shaft rotation monitor sensor 40 and the anemometer 20. The wireless shaft rotation monitor sensor 40 is connected to the shaft along with a wind anemometer 20 in the rear of nacelle. The wind anemometer 20 may monitor wind speed and shaft rotation, which may activate the hydraulic pumps to fill the propeller at the top of the rotation cycle. Further, the wind turbine system of the present invention includes a reserve tank 50 within the nacelle of the turbine that is connected with the reservoirs of the blades through connection member 60 and collects fluid from all the reservoirs of the blades when the wind speed and speed of rotation of propeller is normal and does not require external efforts for its motion.

According to one another embodiment, the three propellers may have the same design with a reservoir and wireless operated pump self-contained however an actual operation only one propeller may need to be activated. The other two propellers in another embodiment can have fake reservoirs just to keep the weight the same. Further, there may be a rechargeable battery is configured to operate the pump within the propeller of system.

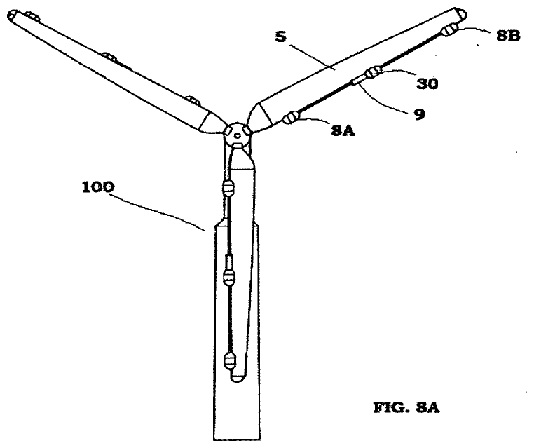

FIG. 7 illustrates another exemplary embodiment of a propeller with a pair of symmetrical blades 3 of present invention in between two shorter hollow blades 3A to manipulate the rotation. According to one embodiment, the hollows propeller is made of a pair of symmetrical long blades 3 and a pair of symmetrical shorter hollow blades 3A in between the long blades 3 that may consists a reservoirs for fluid and a wirelessly controller manipulation pump that manipulates fluid within the reservoirs and creates an in-balance in the movement of the propeller to continuously rotate the propeller even in no wind or low wind conditions. According to one more embodiment, the shorter blades 3A of the propeller may comprise of a fluid and reservoirs of fluid within the hollow portion of the blade 3A to allow manipulation of fluid within the propeller blade 3A to keep the propeller rotating in no/low wind conditions such as wind speed of less than 15 km/h and to forcefully decrease and maintain speed of rotation in high wind conditions such as wind speed of more than 90 km/h.

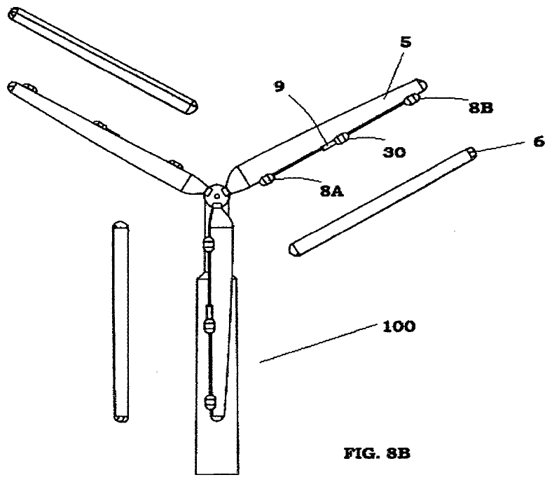

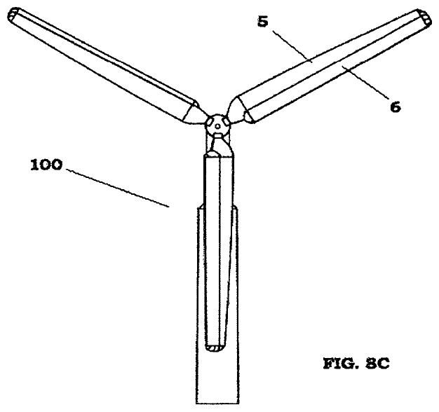

Now referring to FIGS. 8A, 8B and 8C which discloses one another embodiment of wind turbine 100 with propeller of present invention made on the conventional existing propellers by retrofitting fluid reservoirs (8A & 8B) and pump assembly 30 over the blades 5 of the conventional propeller and enclosing the retrofitted reservoir (8A & 8B) and pump assembly 30 using the enclosing member 6. FIG. 8A discloses a pump 30 and fluid reservoir assembly (8A & 8B) attached over the conventional existing propeller blade of wind turbine. FIG. 8B discloses retrofitted pump 30 and fluid reservoir assembly (8A & 8B) over the propeller blades 5 and an enclosing member 6. While the FIG. 8C discloses a propeller blades 5 enclosing member 6 attached over it to enclose the pump 30 and fluid reservoir assembly (8A & 8B) between them to protect from external and environmental problems.

Further, based on the simulation using ANSYS simulation software, it is concluded that injecting fluid to the tip of the only one blade of the three, increased the rotation by 104%. Some tabular data of simulation using ANSYS simulation software is as below:

| | Free Rotating Blade | | Top Weight Attached | |
|---|---|---|---|---|
| Physical time accomplished | 3.5 | seconds | 3.3 | seconds |
| RPM | 7.5 | rpm | 15.3 | rpm |

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A wind turbine system for continuous motion of a turbine; the wind turbine system comprising:
a hollow propeller having a plurality of hollow blades and a hub;
at least one fluid reservoir configured within each of the plurality of hollow blades at a tip and at a stem near the hub of the hollow propeller, wherein the at least one fluid reservoir is capable of collecting and storing a fluid;
at least one pump configured within each of the plurality of hollow blades, wherein the at least one pump is connected to the at least one fluid reservoir for transferring the fluid back and forth within the at least one fluid reservoir;
at least one wireless control unit communicatively coupled with the at least one pump to control the action of the at least one pump;
at least one wireless shaft rotation monitor sensor attached to a propeller shaft and configured to monitor and transmit angle and position of the propeller shaft to the at least one wireless control unit; and
at least one anemometer attached at a rear portion of a nacelle of the wind turbine system and configured to monitor and transmit speed of wind to the at least one wireless control unit;
wherein the at least one pump is configured to:
pump the fluid into the at least one fluid reservoir at the top of the rotation cycle as a counter weight resulting in movement of the hollow propeller downwards, in low wind condition;
pump the fluid out of the at least one fluid reservoir at the lowest point of the hollow propeller's rotation revolution to complete a cycle; and
to manipulate fluid within the at least one fluid reservoir to slow down the hollow propeller in reverse condition when the hollow propeller is at a maximum critical speed.

2. The wind turbine system of claim 1, wherein the at least one fluid reservoir creates an imbalance of weight at top of the hollow propeller to keep the hollow propeller moving in a circular motion.

3. The wind turbine system of claim 1, wherein an imbalance is created by transferring the fluid from a first fluid reservoir being one of the at least one fluid reservoir into an another fluid reservoir being another one of the at least one fluid reservoir of the plurality of hollow blade.

4. The wind turbine system of claim 1, wherein each of the plurality of hollow blades of the hollow propeller are configured to have a same design with the at least one fluid reservoir and the wireless operated pump self-contained within each of the plurality of hollow blades.

5. The wind turbine system of claim 1, wherein at least one pump of only one of the plurality of hollow blades is required to be activated to pump the fluid and rest of the hollow blades have the same design to keep the weight same.

6. (canceled)

7. The wind turbine system of claim 1, further comprising a reserve tank within the nacelle and configured to be connected with the at least one fluid reservoirs configured within each of the plurality of hollow blades.

8. The wind turbine system of claim 7, wherein the reserve tank is configured to collect fluid from all the at least one fluid reservoir configured within each of the plurality of hollow blades when no external effort for the motion of the hollow propeller is required.

9. The wind turbine system of claim 1, wherein the at least one pump is provided within the plurality of hollow blades along with the at least one wireless control unit.

10. The wind turbine system of claim 1, further comprising a rechargeable battery disposed within the hollow propeller and is configured to operate the at least one pump.

11. A method of working of a wind turbine, the method comprising:
providing a wind turbine system comprising:
a hollow propeller having a plurality of hollow blades and a hub;
at least one fluid reservoir configured within the plurality of hollow blades at a tip and at a stem near the hub of the hollow propeller, wherein the at least one fluid reservoir is capable of collecting and storing fluid;
at least one pump configured within the plurality of hollow blades, wherein the at least one pump is connected to the at least one fluid reservoir for transferring the fluid back and forth within the at least one fluid reservoir;
at least one wireless control unit communicatively coupled with the at least one pump to control the action of the at least one pump;
at least one wireless shaft rotation monitor sensor attached to a propeller shaft and configured to monitor and transmit angle and position of the propeller shaft to the at least one wireless control unit; and
at least one anemometer attached at the rear of a nacelle of the wind turbine system and configured to monitor and transmit speed of wind to the at least one wireless control unit;
pumping the fluid into the at least one fluid reservoir at the top of the rotation cycle as a counter weight resulting in movement of the hollow propeller downwards, in low wind condition;
pumping the fluid out of the at least one fluid reservoir at the lowest point of the hollow propeller's rotation revolution to complete a cycle; and
manipulating fluid within the at least one fluid reservoir to slow down the hollow propeller in reverse condition when the hollow propeller is at a maximum critical speed.

12. The method of working of the wind turbine of claim 11, wherein pumping of the fluid at the top of the at least one fluid reservoir aids in a counter weight to increase an angular momentum driving weight of the hollow propeller and accelerating the speed towards the downward direction.

13. The method of working of the wind turbine of claim 11, wherein repetition of each revolution filling and emptying the at least one fluid reservoir sequentially in the hollow propeller rotation at a desired position according to the hollow propeller location occurs to keep the wind turbine continuously rotating even in a low or no wind conditions.

14. The method of working of the wind turbine of claim 11, wherein the method further includes heating the fluid to a temperature to prevent wind turbine from freezing.

15. The method of working of the wind turbine 11, wherein the method further includes combining aerodynamic and non-aerodynamic of the hollow propeller to generate electricity through rotation.
